(19) United States
(12) Patent Application Publication
(10) Pub. No.: US 2002/0036988 A1
(43) Pub. Date: Mar. 28, 2002

(54) Method for designing rings in telecommunications network

(75) Inventors: Richard H. Cardwell, Leonardo, NJ (US); Ondria J. Wasem, West Windsor, NJ (US)

Correspondence Address: COLEMAN SUDOL SAPONE, P.C., 714 Colorado Avenue, Bridgeport, CT, 06605, US

(73) Assignee: Network Design Tools, Inc.

(21) Appl. No.: 09/915,443

(22) Filed: Jul. 26, 2001

Related U.S. Application Data
(60) Provisional application No. 60/221,685, filed on Jul. 31, 2000.

(51) Int. Cl. H04L 12/26; H04L 12/42

(52) U.S. Cl. 370/238; 370/258; 370/406

(57) ABSTRACT

A network design method proceeds by generating cycles, evaluating the economics of building rings on those cycle, and building any economic rings. Generating a cycle involves picking two endpoints between which two disjoint link and node paths are desired—the two nodes selected are thus nodes on the candidate rings. Once a cycle is generated, various combinations of OADM/ADM nodes on the cycle are tried, from rings using three nodes to rings using all of the nodes on the cycle. The network design method considers a sequence of SONET/SDH and DWDM rings on each cycle generated, and compares the cost of carrying demand by SONET/SDH rings, DWDM rings, and an alternative dual-hub benchmark architecture. The ring constraints such as maximum circumference are applied before ring costs are calculated, and rings violating those constraints are eliminated from consideration. The demand carried by the most economic ring is removed from the input list of demands, and the entire process is repeated until no demand remains or it is not economical to carry the remaining demands by using rings. After all economic rings are considered, any remaining demands are carried on point-to-point systems.

### CROSS-REFERENCE TO RELATED APPLICATION

This application claims the benefit of U.S. Provisional Patent Application No. 60/221,685 filed Jul. 31, 2000.

### BACKGROUND OF THE INVENTION

This invention relates to the design of rings in a telecommunications network. More particularly, the present invention relates to a method for designing rings in a network including optical fibers for carrying telecommunications signals in various formats. The methodology of the present invention can work with either or both DWDM and SONET/SDH technologies.

In a telecommunications network, a “ring” is a sequence of nodes arranged in a “cycle” so that no node is repeated. The “links” between nodes are places where fiber can be placed. Nodes are generally physical locations such as buildings where fiber bundles can be connected to each other and where equipment such as multiplexers, amplifiers, regenerators, transponders, etc., can be placed. Ring design entails in part the making of decisions as to ring placement, i.e., which nodes and which links are to be included. Ring design also concerns the selection of equipment, i.e., what types and rates of multiplexers, amplifiers, regenerators, transponders, etc., and where to place the equipment. Finally, ring design necessarily entails decisions as to what demand to place on the rings.

In the past, the problem of ring design was solved using a SONET Planning Tool (“SPT”). In SPT, the algorithm started with the endpoints of the largest demand and then found other demands with endpoints in proximity therewith and with a high demand to the current community of interest to form a ring. A ring analyzer compared various ring types and rates to carry these demands, in order to find the lowest cost ring. The demands were packed onto the rings by a ring loading algorithm. The cost of the lowest-cost ring was compared to the cost of a benchmark architecture (point-to-point) and the ring would be considered only if the cost was lower than that of the benchmark. Further nodes were added one by one to the community of interest, with rings being analyzed each time. The ring with the greatest savings so far over the benchmark was always saved. When it was no longer feasible to add nodes to the community, the saved ring was added to the network design, and the algorithm continued to work on the remaining demands. Demands left over after forming all economical rings were routed on interconnected rings and point-to-points.

This network ring design process is described in U.S. Pat. No. 5,546,542. See also “Method for Efficiently Determining the Direction For Routing a Set of Anticipated Demands Between Selected Nodes on a Ring Communication Network,” S. T. Cosares, I Sanee, O. J. Wasem, Bell Communications Research, Inc., Aug. 13, 1996.

This ring design method tends to favor large rings with awkward routings, due to the benchmark used. In this method, there is a propensity to place demands on a ring based on the sizes and geographic proximities of the demands, rather than on their locations on a cycle (i.e., without considering the connectivity of the network). The loss model of this prior solution allows specification of a distance threshold for placing regenerators and uses a simple method of division to determine how many regenerators to place. This is inaccurate, since generally regenerators must be placed at nodes, requiring practical solutions to have possibly more regenerators that the output solution of the tool.

The models used for SONET/SDH provide for the following costs and parameters: (1) frame and installation, (2) regeneration loss thresholds, (3) maximum number of SONET ADMs on a ring, and (4) fiber material, sheath installation, and structure expansion cost.

Currently, Dense Wavelength Division Multiplexing (DWDM) is being installed largely on long-distance routes. The DWDM vintage normally used is point-to-point DWDM, or in other words, DWDM systems are utilized as fiber concentrators. The reason for this equipment being so prevalent for long-distance carriers is simple economics: DWDM can substantially reduce capital investment because of the ability to multiply the number of signals being carried by each fiber and thus avoid expensive cable or route upgrade and also save the cost of multiple regenerators. While the economics of DWDM are well known and relatively easy to calculate for long-distance applications, DWDM economics for metropolitan areas are much more elusive. While DWDM economic studies in metropolitan areas have indicated capital savings, the advantages of DWDM need more sophisticated analysis to realize any potential savings. Point-to-point DWDM, which uses only the concentration ability of the new technology, may be the first DWDM application, but more sophisticated DWDM architectures are possible. In particular, DWDM rings have been announced, and optical cross-connects are now available. A relatively simple spreadsheet analysis is often sufficient for DWDM point-to-point system economic evaluation, but the design of networks which can utilize DWDM rings is another matter.

Ring structures have proven to substantially reduce necessary capital investment in SONET and SDH networks; recent economic evaluation work supports the notion that DWDM rings share the ability to save capital along with their SONET/SDH counterpart rings. Moreover, the cost of DWDM equipment for metropolitan areas has fallen mostly due to increasing facility to make equipment with these new technologies, and due to mass production techniques. The cost of DWDM equipment for metropolitan areas is substantially below the cost of long-distance DWDM since the distances are shorter, meaning less sophisticated equipment is needed, and amplifiers are not necessarily needed. Recently, a number of products that provide reconfigurable optical add-drop and optical cross-connection capability in a proprietary manner have become commercially available. A flexible optical layer is achieved through a network of interconnected reconfigurable optical add-drop multiplexers (OADMs) and optical cross-connects (OXCs). Such an optical transport network (OTN) will provide a high-capacity optical networking infrastructure in which the optical connectivity is reconfigurable and can readily be changed as the demand pattern varies or faults occur. In such networks, optical terminal multiplexers (OTMs) are used to create point-to-point DWDM systems. OADMs are used to support linear chain and ring topologies while OXCs also permit optical mesh topologies and ring interconnections in an OTN. The advantages of the OTN are increased if it is based on transverse compatible equipment with a common set of minimal functions.

Because of the unique structure of DWDM rings, new techniques are needed to decide where to use DWDM rings.

Standards allow the network provider to deploy a network that is based on an industry wide set of common functions and features and equipment that is interoperable. Vendor independence and multivendor interoperability are enabled by standards. Standards also drive down equipment costs. The primary ITU recommendation for WDM systems is G.692 “Optical interfaces for multichannel systems with optical amplifiers.” Also, Telcordia publishes a suite of Generic Requirements (GRs) designed to allow deployment of interoperable metropolitan DWDM networks. Telcordia publication GR-2918-CORE addresses the physical layer optical specifications and OAM&P functionality of metropolitan DWDM networks and defines a number of application codes that support various network applications and equipment configurations. Telcordia publication GR-2979-CORE provides generic equipment requirements for OADMs and OTMs and optical protection architectures. Thus, the requirements set forth in publication GR-2979 enable survivable optical networks that have optical add-drop functionality. Telcordia publication GR-3009-CORE provides generic criteria for OXCs and enables optical mesh and interconnected ring networks through optical cross-connect functionality. Criteria specified in Telcordia publications GR-2918, GR-2979, and GR-3009 are based on current views of the functional criteria of optical network elements in both the national (ANSI) and international (ITU-T) standards bodies, with relevant enhancements and extensions of the current ITU-T Recommendations.

### OBJECTS OF THE INVENTION

It is an object of the present invention to provide a method for designing rings in a telecommunications network.

It is a more particular object of the present invention to provide such a method which designs economical DWDM and/or SONET rings.

Another particular object of the present invention is to provide such a method which selects placement of DWDM and/or SONET rings, the types, rates and locations of equipment on each ring, and what demands to place on the rings.

A further object of the present invention is to provide such a method which uses high-level models that capture the essence of equipment and physical constraints, but do not go into great detail as to the exact nature of physical impairments.

It is an additional object of the present invention to provide such a method which determines where DWDM or SONET/SDH rings make economic sense.

These and other objects of the invention will be apparent from the drawings and descriptions hereof. Although every object is believed to be met by at least one embodiment of the invention, no embodiment necessarily meets every object of the invention.

### SUMMARY OF THE INVENTION

The present invention concerns methods used to design ring networks, particularly metropolitan SONET and DWDM ring networks.

Previous studies have shown that DWDM proves in economically over SONET when distances are relatively long, and demand is relatively high. Thus, the expectation is to find DWDM most economical in long distance networks, or congested metropolitan networks. Additionally, it would not be unexpected to find that loading much demand onto a single DWDM ring is more economical than building multiple SONET rings to carry the same demand.

However, there are issues to consider in deploying DWDM networks that do not arise in deploying SONET networks. At the strategic level, questions arise as to when to deploy amplifiers and when to employ regenerators. Also, questions arise as to what signal rates should be used on each wavelength. Which nodes can economically share capacity on a DWDM ring? How should rings interconnect? A network design method in accordance with the present invention addresses these issues. However, engineering issues are beyond the scope of the present invention. Thus, a design method as described herein does not address such issues as how many amplifiers can be cascaded, how much distance can be covered before regeneration is required, how long an optical path can be, and how should some of these constraints change depending on the number of wavelengths in the system, the type of fiber used, and the quality of the transceivers.

The present invention is directed to an automated or computerized method for selecting or designing economic rings (see definitions below) including DWDM rings in a telecommunications network. More particularly, in response to input parameters specified by an operator, the method of the present invention deduces (a) where to place rings, i.e., selects a set of nodes and a set of links for each ring, (b) how to equip the rings, i.e., the types and rates of multiplexers, amplifiers, regenerators, transponders, etc., and (c) what demands to place on the rings. The rings are selected or designed pursuant to a cost minimalization algorithm which operates on the various input parameters including a given network topology, demands that the network must carry, and a set of candidate SONET/SDH and WDM equipment. The network topology includes the nodes between which demand is routed, routes between nodes where fiber can be installed, and the number of spare fibers available for use in any route. The network model might also include a list of embedded rings, which have spare capacity that can be used to carry new demands and thus reduce network cost. The present invention is directed to solving a single-planning period problem. Network growth is not being modeled from year to year; instead, a network is built for one period, considering economic factors within that period. Year-to-year growth can be approximated in this model by utilizing the embedded system feature and allowing growth for one year to use spare capacity from the previous year.

A network design method in accordance with the present invention is a strategic planning tool in that it uses high-level models that capture the essence of equipment and physical constraints, but do not go into great detail as to the exact nature of physical impairments. Equipment constraints may include how many wavelengths are on a fiber (system capacity) and whether transponders are necessary. Physical constraints include how far a signal can go in terms of loss before amplification or regeneration is necessary. A more detailed physical impairment model, on the other hand, might include reflections from splices, loss per individual splice, and dispersion compensation. The problem addressed by the present invention is where DWDM or SONET/SDH rings make economic sense. Physical constraints are handled at a rather high level, via equipment characteristics such as maximum span loss supported and maximum number of network elements before regeneration, to allow a search for feasible and economic solutions to the ring placement problem. A more detailed analysis employing more accurate signal impairments can be done after this design step is complete to ascertain if the recommended ring layout is feasible. Thus, a network design method in accordance with the present invention does a strategic planning step of finding economic rings; an additional engineering step will be necessary to ensure that the rings will work as specified. Should difficulty be experienced with the feasibility of a DWDM network designed in accordance with the present invention, the input parameters of loss, circumference and so forth can be changed and the process repeated.

To find low cost rings, a network design method in accordance with the present invention must first find candidate ring locations. In other words, the method must determine places where rings can be built. A cycle is a sequence of nodes tracing a path from the origination node, through intermediate nodes, and back to the origination node such that no node is repeated. A cycle is then a set of disjoint paths and nodes that can be used for ring formation. A DWDM and/or SONET network design method in accordance with the present invention proceeds by generating cycles, evaluating the economics of building rings on that cycle, and building any economic rings. Generating a cycle involves picking two endpoints between which two disjoint link and node paths are desired - the two nodes selected are thus nodes on the candidate rings. Once a cycle is generated, various combinations of OADM or ADM nodes on the cycle can be tried, from rings using three nodes to rings using all of the nodes on the cycle.

A network design method in accordance with the present invention considers a sequence of SONET/SDH and DWDM rings on each cycle generated, and compares the cost of carrying demand by SONET/SDH rings, DWDM rings, and the alternative benchmark architecture. The ring constraints such as maximum circumference are applied before ring costs are calculated, and rings violating those constraints are eliminated from consideration. The best rings, those rings costing the least, are then built by assigning demand to them. Then the demand carried by the most economic ring is removed from the input list of demands, and the entire process is repeated until no demand remains or it is not economical to carry the remaining demands by using single rings.

After all economic rings are considered, any remaining demands are carried on point-to-point systems. Once again, the most economic choice of SONET/SDH or DWDM is used to carry the demand. Only diverse protection is used for point-to-point systems, thus ensuring that each demand is protected against fiber cuts.

A method for designing a telecommunications network comprising a plurality of nodes and links interconnecting each of the nodes with one or more other nodes of the network comprises, in accordance with the present invention, (a) inputting, into a computer, identifications of the nodes and the links of the network and demands between pairs of the nodes, (b) operating the computer to define a series of rings and evaluate costs for each of the rings to determine a least-cost signal transmission structure for the network, and (c) building the least-cost signal transmission structure. The operating of the computer includes (d) defining a set of demands, the set of demands initially consisting of the input demands, (e) selecting a largest demand from the set of demands, the largest demand being associated with a first node and a second node, and (f) generating a cycle between the first node and the second node, where the cycle includes a first path and a second path each of nodes and links extending between the first node and the second node and where the second path has nodes and links all different from nodes and links of the first path (except the end points). The operating of the computer further comprises (g) selecting different combinations of nodes on the cycle. Each such combination includes the first node and the second node and at least one other node on one of the first path and the second path. All of the nodes in any given one of the combinations have at least one demand to another node of the given one of the combinations. The method additionally comprises (h) determining a cost to construct each of the combinations and (i) executing cost comparisons on the combinations to ascertain the least-cost signal transmission structure in terms of cost/carried demand unit for carrying the demand on the ring.

The cost determination preferably includes first costing installation of SONET/SDH equipment on the nodes of the combinations, to thereby determine cost of SONET/SDH rings, and then costing installation of OADMs on the nodes of the combinations, to thereby determine cost of WDM rings. The cost of any least-cost SONET/SDH ring is compared with the cost of a dual-hub architecture for the same demand carried by the least-cost SONET/SDH ring. Similarly, the cost of any least-cost WDM ring is compared with the cost of a dual-hub architecture for the same demand carried by the least-cost WDM ring. Ring structures are saved for possible future construction only if their costs are less that those of the corresponding dual-hub architectures.

The set of demands is redefined upon completing the analysis of a cycle, by eliminating the demand which was routed on the ring. If no ring was saved, then the largest demand is marked so as not to be used for cycle generation a second time.

The ring design method of the present invention grows a community of interest by selecting a node from among the other nodes residing on the current cycle of interest and adding that selected node to the current ring community. Thus, nodes are selected for possible inclusion in a ring only if the nodes are already present on the current cycle of interest. In contrast, prior art methods may add nodes from anywhere in the network. Previous technology (SONET) dictated that nodes sharing bandwidth on a single ring have like size demands on the ring for efficient bandwidth sharing. This led directly to the idea that nodes should be added to a ring based on demand size and not based on whether the node is contained in the current cycle.

The ring design method of the present invention compares cost in units of currency per input demand unit rather than merely in units of currency. This method allows for fair comparison among architectures that do not carry equivalent demand. In other words, the method loads rings with the maximum amount of demand they can carry and compares rings in terms of cost per unit of demand carried. Thus rings of different capacities can be compared. In general, not all demand applied to the nodes selected to be ring nodes is carried by the ring.

A network design method in accordance with the present invention facilitates construction of a lower cost network than that achieved with prior design methods. The present design method contemplates accurate placements of all equipment, including amplifiers and regenerators, whereas prior solutions did not produce accurate regenerator counts.

A network design method in accordance with the present invention handles configuration not only of metropolitan area networks but also of large regional networks including both densely and sparsely populated areas. Demand is clustered into areas dictated by either administrative and/or distance constraints. The design algorithm is executed on each area, followed by an interconnection of demand between areas.

A network design method in accordance with the present invention is quicker and more flexible than prior processes. The method allows arbitrarily complex consideration of network and demand constraints when placing rings during the optimization process. Additional parameters allow an expert user more flexibility in discovering effective network solutions.

The use of a dual-hub architecture rather than a point-to-point architecture as a benchmark in the instant methodology eliminates a bias towards larger rings.

### BRIEF DESCRIPTION OF THE DRAWINGS

FIG. 1 is a block diagram of a generic metropolitan telecommunications network.

FIG. 2 is a block diagram of the network of FIG. 1, where a cycle is generated in a software simulation for carrying a largest demand outstanding on the network.

FIG. 3 is a block diagram of the network of FIGS. 1 and 2, showing a software defined ring carrying demands among the endpoints of the largest demand and the node that has the highest demand to them.

FIG. 4 is a block diagram of the network of FIGS. 1-3, showing another software-defined ring carrying the demand of the ring in FIG. 3, plus the demand between the ADM nodes of FIG. 3 and the node with the highest demand to them.

FIG. 5 is a flowchart illustrating steps or routines in a network ring design method in accordance with the present invention.

FIG. 6 is a flowchart showing details of a cycle and node selection routine depicted in FIG. 1.

FIG. 7 is a block diagram of an actual metropolitan telecommunications network.

FIG. 8 is a block diagram of another example of a metropolitan telecommunications network.

### DEFINITIONS

A “node” as that term is used herein refers to a central office location (i.e., a building or other fabricated structure) where equipment can be placed. The term “add-drop node” refers to a node functioning as an origination and/or termination point for demand that must be carried by a ring, and containing an (optical) add-drop multiplexer for this purpose.

The word “equipment” is used herein to denote optoelectronic devices which perform various functions in the conveyance of information bearing signals over telecommunications networks. Different kinds of equipment function to place signals onto optical fiber, enable the transmission of optical-frequency signals over long distances, convert signals from one form to another, take signals off of a network, etc. Specific examples of equipment include multiplexers, amplifiers, regenerators, transponders, etc.

The word “link” is used herein to denote a route where fiber is already installed or can be placed. Thus, a telecommunications company owns a right of way in these places. In the design process of the present invention, links are found in the problem definition input files (user defined).

The term “demand” refers herein to a need for number of units of a specific bandwidth between two nodes. The demands must be carried on some ring system or point-to-point system.

For instance, a demand may be four units of OC3 (155 megabits/second). Demand refers in general to any need for bandwidth between two nodes. There are separate demands for each bandwidth and each pair of nodes. A node can be associated with demand, or can be only an interconnection point between fiber links. Demands carried on a ring originate and terminate on the add/drop multiplexers on the ring, the ADMs always being located at a node. Demand not carried by one ring will be carried by some other ring (or point-to-point).

The word “cycle” denotes a path that starts at one node, goes through a sequence of nodes, and returns to the beginning node without repeating a node. A cycle is thus a set of disjoint path segments (links) and nodes that can be used for ring formation. A design method in accordance with the instant disclosure entails generating cycles and evaluating the economics of building rings on each cycle. Economic rings are subsequently built. Generating a cycle involves picking two endpoints between which two disjoint link and node paths are desired, the two nodes selected being nodes on the candidate rings. Once a cycle is generated, various combinations of add-drop nodes on the cycle can be tried, from rings using three nodes to rings using all of the nodes on the cycle.

The “current cycle of interest” is the cycle under consideration at any particular time by the ring network design computer, for purposes of defining possible rings. The algorithm proceeds by generating a cycle and trying various combinations of ring add/drop nodes on that cycle. The “current cycle of interest” is thus the cycle generated currently by the pair of shortest disjoint paths between the two nodes having the largest demand as yet unprocessed.

The word “ring” is used herein to designate a subset of the sequence of nodes arranged in a “cycle” so that no node is repeated and so that the “links” between nodes are places where fiber can be placed. All nodes on a ring have add/drop multiplexers (ADMs) (DWDM or SONET) where demand can be added or dropped to/from the ring. Some nodes in the cycle are “through” nodes that are only splicing points for the fiber. In the ring design method disclosed herein, nodes on a cycle are added to a ring only if the nodes have demand to nodes already on the ring. The node with the largest total demand to the nodes already on the ring is added at each step.

A “ring community” as that term is used herein represents the nodes on a ring that have add/drop multiplexers.

The word “design” is here used to designate a process of determining where to place or, in other words, where to install rings. This process of the present invention contemplates an automated method for selecting near-minimum-cost networks given a network topology, demands that the facility network must carry, and a set of candidate SONET/SDH and WDM ring equipment. The design methodology of the present invention may find in some instances that it is economic to install DWDM rings in the heart of a city, but more economic to install SONET/SDH rings in the suburbs of that city due to a smaller demand level in the suburbs. The output of this design process is a set of rings (both DWDM and SONET/SDH) together with point-to-point systems that carry demand that could not be economically assigned to rings.

The term “benchmark” is used herein to denote a reference network structure or architecture, not a DWDM ring architecture, which is used for cost comparisons in the present methodology. The preferred benchmark architecture is a dual hub architecture. However, it is possible for a point-to-point architecture to be used in some cases.

### DETAILED DESCRIPTION AND DESCRIPTION OF THE PREFERRED EMBODIMENTS

The present method for designing ring structures in a telecommunications network generates or selects cycles of network links and nodes, chooses at which nodes to place what types of equipment, and assigns demand over that set of nodes, links, and equipment.

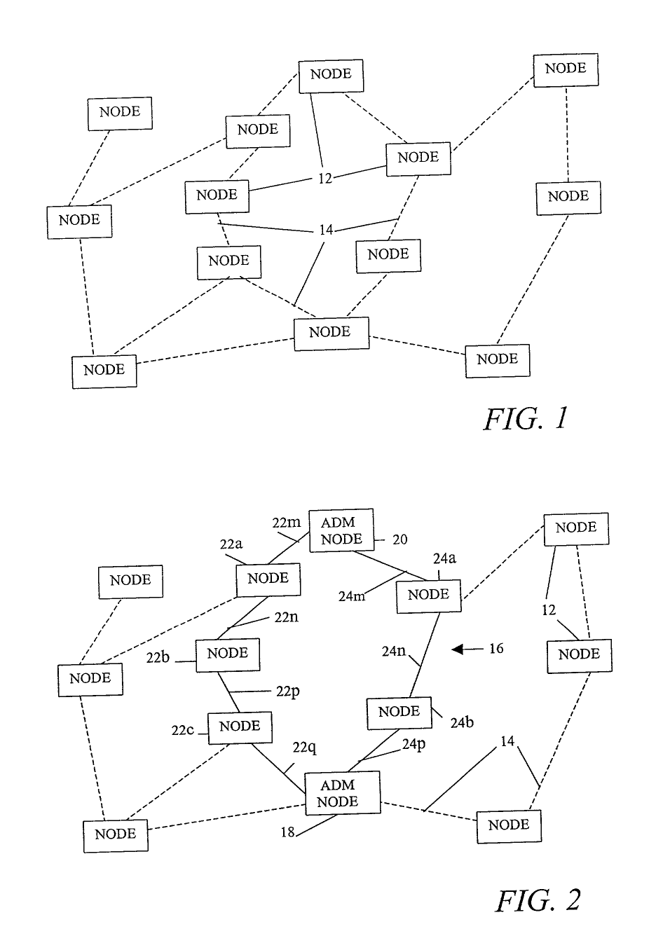

As illustrated schematically in FIG. 1, a metropolitan telecommunications network comprises in part a multiplicity of nodes 12 between which are physical links 14, such as optical fiber, or rights of way to install physical links 14. An object of network design is to determine the paths over which demand is to be routed among the nodes 12 and to select which kinds of equipment, if any, are to be installed in the various nodes 12. The present methodology designs rings by finding cycles of network links 14 and nodes 12, choosing at which nodes 12 to place what type of equipment, and routing demand over that set of nodes, links, and equipment. It is desirable to find a relatively low cost network design. The instant method seeks to use dense wavelength division multiplexing (DWDM) and/or SONET/SDH, for purposes of minimizing costs.

At the onset of a process for designing ring structures to accommodate telecommunications traffic in the metropolitan network of FIG. 1, the user or operator inputs into the design computer (not shown) relevant parameters and constraints. With respect to SONET/SDH networking, the starting data includes (1) frame and installation, (2) regeneration loss thresholds, (3) maximum ring circumference, (4) maximum and minimum numbers of SONET ADMs on a ring, and (5) fiber material, sheath installation, and structure expansion, as well as costs of the various pieces of equipment and hardware.

The model for SONET/SDH equipment used in a network design method as described herein is identical to the model being used today in other planning tools. The reason that SONET/SDH equipment is included in the network design method is that at least some demand can be carried via SONET/SDH even in networks which can utilize DWDM. Also, DWDM systems usually carry SONET/SDH signals, so one can consider DWDM as an extension of SONET/SDH multiplexing techniques. Hence, the cost comparisons which must be made by the network design tool include comparing SONET/SDH alone with SONET/SDH over DWDM.

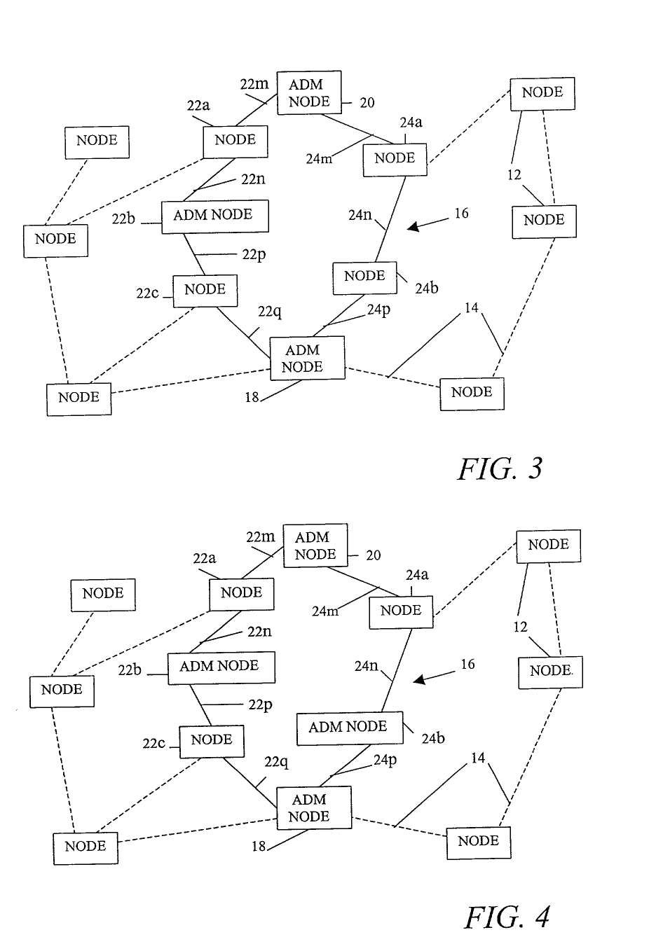

For the design of DWDM network rings, the equipment model includes costs related to (1) frame and installation, (2) signal sources, including transponders for use with the SONET/SDH equipment model described above and SONET/SDH plugins for equipment that uses built-in SONET/SDH equipment, (3) loss before amplification, (4) number of DWDM “spans” before regeneration (explained below), (5) maximum circumference of WDM ring in kilometers, (6) maximum and minimum numbers of wavelength add/drop multiplexers on a ring, and (7) fiber material, sheath installation, and structure expansion. The relevant costs, parameters, and constraints are input into the computer running the design method as discussed hereinafter with reference to FIGS. 2 and 3.

This DWDM equipment model allows much more generality than is possessed by DWDM equipment today. In this model, DWDM equipment can utilize built-in SONET/SDH plugins to multiplex input signals to the appropriate line rate and place these signals on the proper wavelengths. On the other hand, the instant network design method allows the use of transponders, in which case a normal SONET/SDH multiplexer is used to multiplex signals to the line rate and the transponder changes that signal to the appropriate wavelength. The corresponding costs are included in the final cost of the DWDM ring for comparison with other alternatives as discussed hereinafter.

Regeneration involves demultiplexing a DWDM signal into its component wavelengths, doing an optical to electrical transformation, regenerating the signal, doing an electrical to optical signal conversion to the proper wavelength, and multiplexing the wavelengths into a composite signal. A network design method as described herein determines where to put regenerators by counting the number of optical “spans.” An optical span extends between adjacent active DWDM elements, as for example a segment from an OADM to an amplifier is considered one span. For each piece of DWDM equipment, there is a number specifying the maximum number of optical spans before the signal needs to be regenerated or dropped to a SONET ADM or plugin. If regeneration is needed, appropriate costs are included in the ring cost.

Included in the parameters and constraints entered by a user prior to the initiation of the automated design methodology are the various demands among the nodes 12 in the metropolitan telecommunications network. The parameters or constraints may include not only a maximum number of ADMs as in prior solutions but also a minimum number of ADMs and a maximum ring circumference. These parameters allow for network designs that would otherwise be missed.

Generally, the instant ring network design method takes a cycle based approach which first locates a good cycle and then adds nodes to the ring from that cycle. A cycle 16 (FIG. 2) is selected to carry the largest demand in the network which has yet not been allotted to a path. Cycle 16 is generated to include two base nodes 18 and 20 between which the demand is to be carried, as well as a pair of disjoint or mutually exclusive paths 22 and 24 extending between those base nodes. Paths 22 and 24 are bidirectional, since each link on the ring must have one fiber in each direction. Each path 22 or 24 may include one or more nodes 22a, 22b, 22c or 24a, 24b, as well as a plurality of links or path segments 22m, 22n, 22p, 22q or 24m, 24n, 24p each extending between a respective pair of nodes. Base nodes 18 and 20 necessarily incorporate add-drop multiplexers (ADMs) inasmuch as the selected demand (the largest outstanding demand) is to enter and exit the ring at those nodes.

In a first attempt at finding a low-cost ring to carry the demand between base nodes 18 and 20, the computer carrying out the design methodology canvases the input demands associated with nodes 22a, 22b, 22c and 24a, 24b on the cycle 16 to discover the node having the next-largest demand to the nodes on the cycle. If that node is node 22b, SONET/SDH ADMs and optical add-drop multiplexers (OADMs) will be successively assigned to nodes 18, 20, and 22b (FIG. 3) to determine whether either of a SONET/SDH and a DWDM ring on cycle 16 is lower in cost than the other and lower in cost than a benchmark architecture for carrying the largest demand between nodes 18 and 20 and the demand associated with node 22b and the other nodes on cycle 16. Any such lower-cost ring is saved in memory.

In a second iteration at finding a low-cost ring to carry demand on cycle 16 including the demand between base nodes 18 and 20, the design computer checks the input demands associated with nodes 22a, 22c and 24a, 24b to discover the node having the third-largest demand to the nodes on the cycle. If that node is node 24b, SONET/SDH ADMs and optical add-drop multiplexers (OADMs) will be successively assigned to the node 24b (in addition to nodes 18, 20, 22b) (FIG. 4) to determine whether either of a respective SONET/SDH and a respective DWDM ring on cycle 16 is lower in cost than the other, lower in cost than a benchmark architecture for carrying the demands associated with the nodes on cycle 16 and lower in cost than any previously saved ring. Again, any such lower-cost ring is saved in memory as the lowest-cost ring. Further iterations of the process may involve nodes 22a, 22c and 24a, as well. At then end of this serial testing process, if there is a lowest-cost ring costing less than the benchmark architecture to carry the same demand, the demands on that ring are assigned to the ring (the ring is built). Those assigned or allocated demands are then removed from the list of demands for the network (FIG. 1). The largest remaining demand and an associated cycle between respective base nodes for that largest remaining demand are then selected and the iterative investigation is reinitiated.

Due to the use of both amplifiers and regenerators for WDM, as opposed to only regenerators for SONET, both loss and amplifier noise must be tracked during ring simulation in order to place the proper equipment in the correct location. (Each new ring simulation requires the addition of one or more ADMs and may require the addition of other equipment as well, depending on the relevant parameters and constraints.) The way in which these parameters are modeled and tracked in the instant network design method is discussed below. In general, amplification costs less than regeneration for WDM, since the wavelengths need not be demultiplexed as in regeneration, and consequently regeneration is reserved for recovering from dispersion and amplifier noise.

Unlike in SONET, where each tributary on a system carries the same rate signal, tributaries (wavelengths) in WDM can be mixed, with different wavelengths carrying different rate SONET signals. This increases the complexity of the planning process, due to the increase in the number of choices as to what to put on each tributary of a WDM system.

Besides increasing the complexity of the planning process, mixed tributaries also increase the flexibility of the design. For example, in SONET, where a set of nodes is being chosen to form a ring, it would not be necessary to equip all nodes on a cycle with an ADM. This is because nodes with lower demand might be more economically placed separately from nodes with higher demand. For example, if two nodes had 45 DS3s between them and two other nodes bad 3 DS3s between them, it might be more economical (depending on fiber availability) to purchase two OC-48 ADMs and two OC-3 ADMs rather than four OC-48 ADMs. With WDM, however, lower demand nodes can actually share a WDM ring with higher demand nodes as economically as in the above example, if the lower demand nodes are placed on a different wavelength from the higher demand nodes.

In designing a ring and reckoning the costs thereof, the present network design method takes into account a loss factor for each use of a fiber—either SONET or WDM—in terms of dB per kilometer. Then there is an additional loss component for splicing through an intermediate office—an office loss in dB per office. The office loss is included to more accurately model metropolitan areas where distances are short but many offices are used as via points. When determining where to place amplifiers or regenerators, the present method calculates the appropriate loss from the last amplifier (regenerator) including distance related loss and office loss, and will place an amplifier (regenerator) in the building just before threshold exhaust. In all cases, the instant network design method places amplifiers (regenerators) at particular buildings.

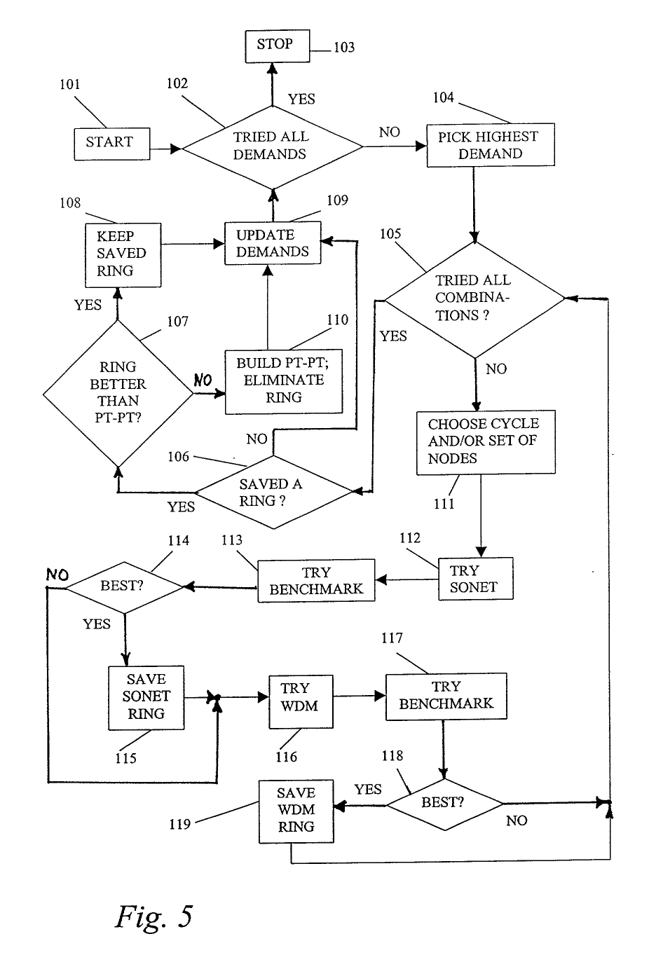

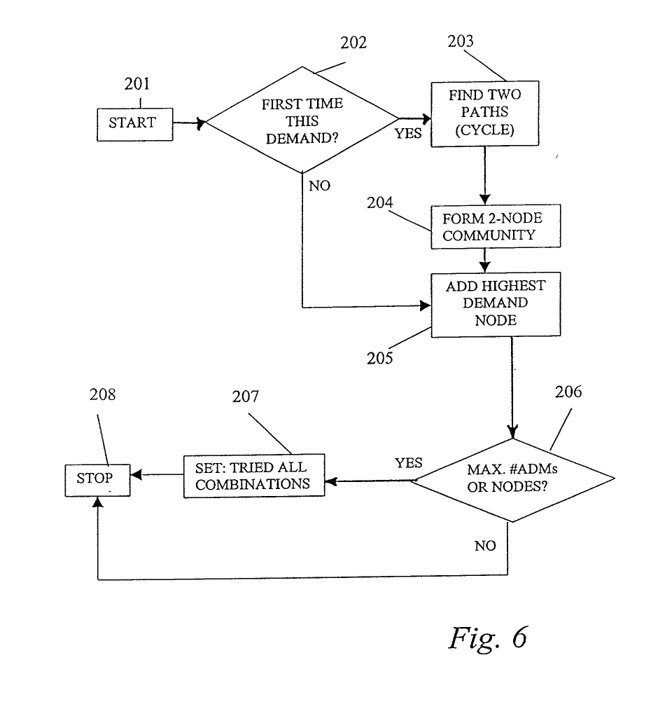

As illustrated in FIG. 5, an initialization step 101 leads to a check 102 as to whether the design process has been completed. The process is terminated at 103 if check 102 reveals that no demand remains to be routed or assigned. If instead check 102 reveals that one or more demands of the set of demands associated with the network of FIG. 1 have not been allocated to a respective path, the design computer (not shown), in a step 104, picks the largest demand waiting to be routed. An inquiry 105 is then made as to whether all obtainable combinations of nodes 12 on cycle 16 (FIGS. 2-4) have been considered. Obtainable combinations of nodes 12 on a ring are those which can be found by the method of FIG. 6. These are limited, since the number of add/drop multiplexers must be within a predetermined range, and nodes are added to find new communities, but never removed or exchanged.

If inquiry 105 reveals that not all permissible node combinations have been tried, another combination is selected in a routine 111. If this is the first attempt for the initial demand chosen, then it is necessary to find a cycle in routine 111.

Details of routine 111 are depicted in FIG. 6. Upon an initialization step 201, a query 202 is made as to whether the most recently selected demand is a new initial demand. If the answer to query 202 is affirmative, a cycle (e.g., cycle 16) for routing this demand is generated first in a step 203 by finding the two shortest disjoint paths (e.g., paths 22 and 24) connecting the endpoints or base nodes (e.g., nodes 18 and 20) of the demand. Surballe's algorithm is used in step 203 to determine the two shortest disjoint paths 22 and 24. In a subsequent step 204, endpoints or base nodes 18 and 20 are provided in simulation with respective ADMs to form a ring community of size two (FIG. 2). Then, whether the most recently considered demand is a new initial demand with a ring community of size two (FIG. 2) or whether the ring community under consideration is of a larger size, a new node is added in a next step 205, that node (e.g., node 22b or 24b) being the node with the most demand to the current ring community. If the new node community has now reached the maximum permissible number of active (ADM, OADM) nodes on a ring, as determined at a decision junction 206, then a flag is set in a step 207 indicating so. Routine 111 terminates at a step 208.

Testing now begins on the new proposed ring set up in step 205. In a routine 112, the ring network design computer searches the SONET equipment that was input (if any), equips the active nodes (e.g., nodes 18, 20, 22b, 24b in FIG. 4) with SONET ADMs of various types and rates, and routes whatever demand will fit over that equipment. For each available type and rate of SONET equipment, the computer calculates the ring cost in dollars per input demand unit (e.g., dollars/DS3) and keeps track of the lowest-cost SONET ring.

After the testing of SONET rings with different combinations of SONET ADMs and the determination of the lowest-cost SONET ring, the ring network design computer executes a routine 113 (FIG. 5) in which the computer attempts to route, on a benchmark dual-hub architecture, the demand that is carried on that lowest-cost (in dollars per input demand unit) SONET ring, using costs of available equipment, or default costs if the input equipment model is inadequate for the benchmark architecture. Again, the method contemplates each type and rate of equipment, with that being selected which results in the lowest cost in dollars per input demand unit.

At a decision junction 114, the per-unit-demand cost of the lowest-cost SONET ring just discovered by the last execution of routine 112 is compared with the per-unit-demand cost of the benchmark architecture and with the per-unit-demand cost of any saved ring for the current initial demand. If the cost of the lowest-cost SONET ring just discovered by routine 112 is the least cost, then that new lowest-cost SONET ring is saved, together with its per-unit-demand cost, in a step 115. Otherwise, the memory contents are not altered with respect to the current initial demand.

Now, in a routine 116, the ring network design computer searches the DWDM equipment that was input (if any) and equips the active nodes (e.g., nodes 18, 20, 22b, 24b in FIG. 4) with OADMs (optical add/drop multiplexers) of various types and rates, as well as any SONET equipment necessary to multiplex demand onto the various wavelengths. Then the computer routes whatever demand will fit over the selected equipment. For each available type and rate of WDM equipment, the computer calculates the ring cost in dollars per input demand unit (e.g., dollars/DS3) and keeps track of the lowest-cost DWDM ring.

Routine 116 tracks loss and amplifier noise during ring simulation in order to place the proper equipment in the correct location. Loss in an optical system occurs due to the length of fiber traversed, or the inclusion of splices in the fiber path. Routine 116 (as well as routine 112) models the loss for traversing a length of fiber as the loss per kilometer of fiber multiplied by the length of the fiber. Routine 116 (and 112) also models the effect of splices by including a loss per office for each office or node 12 traversed without a multiplexer. Thus a “through” office or node 12 will add to the signal loss. Users set the loss parameters through input data. When costing a ring, routine 116 (or 112) calculates the signal loss for each link between add/drop multiplexers on the ring. If the loss thus calculated exceeds the loss allowed by the multiplexer, routine 112 will insert a regenerator (in the case of SONET/SDH) or routine 116 will insert an amplifier (in the case of DWDM) at the last office or node before the loss budget was exceeded. Thus, the method as depicted in FIG. 5 always puts regenerators and amplifiers at actual offices so the resulting equipment placement is realizable. If it is not possible to place regenerators or amplifiers so that the constraints are met, routines 112 and 116 will assign an infinite cost to the respective ring and the ring will not be selected.

Dispersion is modeled as follows. After a signal is converted to an optical signal, it is allowed to pass through a given number of amplifiers before it must be regenerated. Routine 116 keeps track of the number of amplifiers a signal has been though and inserts a regenerator when the given number of allowed amplifiers is exceeded. Once again, routine 116 places these regenerators at actual offices. The cost for these regenerators is included in the ring cost; if a situation is encountered when routine 116 cannot place the required regenerator; routine 116 gives the ring an infinite cost so it will never be selected.

After the testing of DWDM rings with different combinations of OADMs and necessary SONET equipment and the determination of the lowest-cost DWDM ring, the ring network design computer executes a routine 117 in which the computer attempts to route, on a benchmark dual-hub architecture, the demand that is carried on that lowest-cost (in dollars per input demand unit) DWDM ring, using costs of available equipment, or default costs if the input equipment model is inadequate for the benchmark architecture. Again, the method contemplates each type and rate of equipment, with that being selected which results in the lowest cost in dollars per input demand unit.

At a decision junction 118, the per-unit-demand cost of the lowest-cost DWDM ring just discovered by the last execution of routine 116 is compared with the per-unit-demand cost of the benchmark architecture and with the per-unit-demand cost of any saved ring for the current initial demand. If the cost of the lowest-cost DWDM ring just discovered by routine 116 is the least cost, then that new lowest-cost DWDM ring is saved, together with its per-unit-demand cost, in a step 119. Otherwise, the memory contents are not altered with respect to the current initial demand.

If inquiry 105 reveals that all permissible node combinations have been tried, the design computer checks at 106 as to whether a ring has been saved. If no ring had a per-unit-demand cost less than its respective benchmark architecture, then no ring would have been stored. In that case, the initial demand for the cycle (e.g., cycle 16 in FIGS. 2-4) is marked in a step 109 as having been tried as an initial demand. Then check 102 is performed again to determine whether the design process has been completed and the next highest demand is then selected in step 104 as an initial demand for ring formation. The marked demand will be later routed on another ring or on a point-to-point system.

If a ring has been saved, as determined at check 106, then its cost per input demand unit is compared in an inquiry 107 to the cost per input demand unit of putting the initial demand on a point-to-point system. If the cost of the point-to-point system is lower, the point-to-point system is built or allocated to construction in a step 110, while any saved rings for the respective initial demand are discarded. If the cost of the point-to-point system is higher, then the saved ring is designated in a step 108 as being suitable for construction. In step 109, the set of outstanding or unallocated demands for the respective network (FIG. 1) is updated to remove those demands which have been routed onto the new ring (step 108) or the new point-to-point system (step 110).

Again, if there are no further demands to be routed after the updating in step 109, the process is terminated at 103. If further demands remain, as determined at check 102, the largest remaining demand, that is, the largest demand which has not yet been tried as an initial demand, is selected to define a cycle 16 for ring design.

The process illustrated in FIGS. 5 and 6 derives sets of rings of appropriate type and rate to carry the total demand load in the network. The method also produces a cost for the network design. That cost is less than the cost of networks built according to prior art design technology. Moreover, the method described herein is faster than prior methods. The method can be used to determine where in a network DWDM is appropriate, how many wavelengths ought to be used, and where SONET is appropriate. The determination of cost necessarily entails a determination of how much equipment of what type to place at which locations.

The instant network design method can utilize the GR-2918-CORE application codes (and G.692 applications) to plan DWDM networks via the loss before amplification and number of DWDM spans before regeneration parameters.

A network design method as discussed above may explicitly model three reach thresholds for signal amplification, namely, short reach, medium reach, and long reach. It is assumed that all hardware associated with a WDM multiplexer (such as transponder, SONET Plug-in, etc) has a reach identical to that specified by the WDM multiplexer. The reach thresholds used to determine when amplification is required, are input parameters.

The process described above particularly with reference to FIGS. 5 and 6 is for metropolitan areas (FIG. 1) where it is in general possible to reach any node 12 in the network from any other node. That is, rings can be built between nearly any combination of nodes, and point-to-point systems can be built to carry demand between any two nodes. Essentially this means that the distance limitations imposed by the maximum circumference constraints do not come into play. For long-distance networks, where there are greater distances between nodes, the situation is quite different and the method needs to be changed to provide means for placing rings.

To design long-distance networks where distance plays a large part in the allocation of traffic to rings and where demands must traverse more than one ring to go from origination to destination node, the instant network design methodology can be extended as follows. First, clustering methods can be used to partition the network into geographic areas where rings can be built. The standard network design procedures described above can be used for intra-area demand. Once the network has been clustered, the demands within each cluster can be handled as described above, with the addition that all demand from nodes within a cluster to a node outside the cluster now goes to a node designated as an interconnection point. Thus, the ring network design algorithm is executed to find rings and point-to-points within the cluster that satisfy demand between nodes within the cluster and move external demand to the interconnection points.

After each cluster is designed, it remains to process demands between clusters. Another network thus remains composed of interconnection nodes and the demand between them. This problem can be handled as follows. First the normal network design algorithm is run considering the inter-cluster demands. The output of this stage is a set of rings, which can carry at least some of the demand between clusters. Next, it is necessary to find means to route demands that cannot be handled by direct interconnection. These demands can only be handled by assignment to multiple rings and the demands must traverse at least two rings. Capacity can be found to handle these demands by making use of spare capacity in the inter-cluster rings previously found, or by breaking up the demands into segments between interconnection points and executing the network design algorithm again.

Validation of the ring network design tool comes about in two ways. Firstly, SONET/SDH networks designed with the tool can be compared to designs produced by other SONET/SDH design tools, such as Telcordia's SONET/SDH Planning Tool. This will confirm the validity of the solutions. For DWDM networks, since there are no other existing tools that design the placement of DWDM rings, solutions of the tool will be compared to manual solutions on small networks.

### EXAMPLE 1

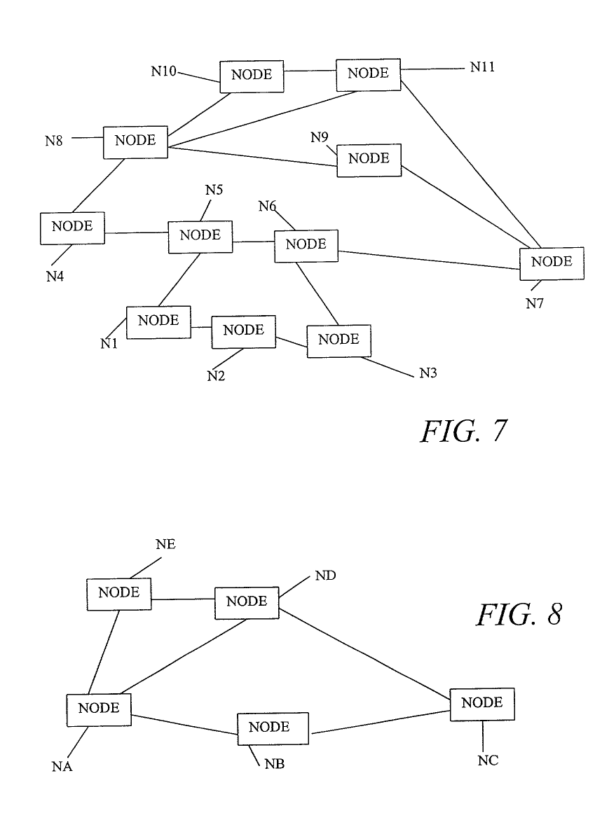

FIG. 7 below shows a layout of an example study network having eleven nodes N1-N11. This network is taken from the downtown area of a large metropolitan LATA. Note that although the network data were taken from an actual LATA, the layout of the network has been altered to preserve anonymity, and the network is not drawn to scale. The actual data used for the network design analysis included fiber links, node locations, demand levels, and cost models for WDM and SONET equipment.

The cost models for DWDM and SONET used here are representative of generic costs for such equipment and were obtained from averaging a variety of vendor prices for identical equipment. A single year study technique was used to demonstrate the results that are representative of metropolitan DWDM and available from the network design method as discussed hereinabove with reference to FIGS. 1-6. It is to be noted that due to the comparatively small distances in the network of FIG. 7, the constraint as to the maximum circumference for rings was not important, and no amplifiers or regenerators were required.

The fiber cost components are shown in Table 1 below.

TABLE 1
Fiber Related Costs

| Component | Cost ($/KM) |
|---|---|
| Fiber Material | 425 |
| Fiber Sheath | 12,750 |
| Fiber Innerduct | 8500 |
| Fiber Conduit Structure | 340,000 |
| Expansion | |

The SONET solution for this network was obtained by running routine 112, with only SONET equipment input. The input data for SONET multiplexers is shown in Table 2 below. The input data signal rate to each piece of multiplexing equipment is assumed to be DS3, the signal rate of all demands in the model network.

TABLE 2
SONET Multiplexer Costs

| Multiplexer Rate | Direction | Number of Fibers | Cost |
|---|---|---|---|
| OC48 | Bi-directional | 4 | 100,000 |
| OC48 | Bi-directional | 2 | 80,000 |
| OC48 | Uni-directional | 2 | 70,000 |
| OC48 | Terminal | 4 | 60,000 |
| OC12 | Bi-directional | 2 | 50,000 |
| OC12 | Uni-directional | 2 | 40,000 |
| OC12 | Terminal | 4 | 35,000 |
| OC3 | Uni-directional | 2 | 22,000 |
| OC3T | Terminal | 4 | 20,000 |

The network design process program ran for about 3 seconds on a 233 MHz PC. A summary of results is shown below in Table 3.

TABLE 3
SONET Network Results Summary

| Cost Component | Cost ($) |
|---|---|
| SONET System Electronics Cost | 8,421,856 |
| Fiber Material Cost | 2,396,694 |
| Fiber Sheath Installation Cost | 8,502,210 |
| Fiber Innerduct Cost | 1,416,535 |
| Fiber Structure Build | 56,662,056 |
| Total Network Cost | 77,399,351 |

Fiber sheath cost refers to the cost of actually installing the cable. Structure build cost refers to adding new conduit routes. The electronics cost refers to all SONET components: multiplexers and regenerators. It is to be noted that for this example there is a significant exhaust problem in the model network, with the addition of expensive conduit being required in the SONET solution.

The cost for DWDM add/drop multiplexing equipment is shown in Table 4 below. It is to be noted that these cost figures are only for the DWDM equipment; each wavelength will have SONET equipment attached. The cost for a transponder is assumed to be $ 10,000.

TABLE 4
WDM Equipment Cost

| Component | Direction | Number of Fibers | Cost ($) |
|---|---|---|---|
| 16-Wavelength OADM | Uni-directional | 2 | 45,000 |
| 32-Wavelength OADM | Uni-directional | 2 | 60,000 |
| 16-Wavelength DWDM | Terminal | 4 | 35,000 |
| Terminal | | | |
| 32-Wavelength DWDM | Terminal | 4 | 50,000 |
| Terminal | | | |

Results from the network design program, carried out by routine 116, are summarized in Table 5 below. Note that the cost of WDM and SONET electronics have been combined for the purposes of this report.

TABLE 5
WDM and SONET Network Cost

| Cost Component | Cost ($) |
|---|---|
| WDM and Sonet System Electronics Cost | 9,515,850 |
| Fiber Material Cost | 1,050,600 |
| Fiber Sheath Installation Cost | 6,117,960 |
| Fiber Innerduct Cost | 1,100,617 |
| Fiber Structure Build | 44,025,176 |
| Total Network Cost | 61,810,203 |

The DWDM solution is substantially less expensive than the SONET solution, largely due to the ability to avoid conduit exhaust. The total cost saving for this example is about 20 percent. On the other hand, one should not regard DWDM as only applying to exhaust situations, as in this example, the cost for SONET electronics and fiber was $10,818,550, while the cost for the SONET/DWDM electronics, WDM, and fiber was $10,566,450. Thus the savings in eqipment costs for DWDM was about 2-3 percent.

### EXAMPLE 2

The exemplary network of FIG. 8 has five nodes NA, NB, NC, ND, and NE and six links NA-NB, NB-NC, NC-ND, ND-NE, NE-NA, and NA-ND. It is assumed that the largest as yet unprocessed demand is between node NA and node NC. Then the process described above particularly with reference to FIGS. 5 and 6 will generate the cycle consisting of node NA, link NA-ND, node ND, link ND-NC, node NC, link NC-NB, node NB, and NB-NA. This example assumes that each link is one unit long. Now consider that the demands on this cycle are:

TABLE 6
Examples of Demands in Network

| From | To | |
|---|---|---|
| Node | Node | Units of Demand |
| NA | NB | 2 |
| NA | NC | 20 |
| NA | ND | 5 |
| NB | NC | 1 |
| NB | ND | 3 |
| NC | ND | 8 |

It is calculated that node NB has 3 units of demand between itself and the current community of interest, that is, nodes NA and NC. This demand includes 2 units of demand between nodes NA and NB and 1 unit of demand between nodes NB and NC. Node ND on the other hand, has demand to node NA (5 demand units) and node NC (8 demand units) for a total of 13 units. Thus, the present ring design method would add node ND to the ring and cost the ring with multiplexers at nodes NA, NC, and ND. The cost of this ring is determined as follows. Each candidate SONET ring add/drop multiplexer is tried in turn during the execution of routine 112 (FIG. 5), and each ring is loaded with the candidate demand described above in such a way that the cost per unit of demand actually carried by the ring is minimized. For example, bi-directional and uni-directional rings carry different demands well and so the demands from the candidate demands are selected so that they minimize the cost/unit of each ring. The ring of the least cost is remembered and its cost per unit is compared to the cost of carrying the same load by the benchmark architecture. If the cost of the benchmark is more than the cost of the ring, the SONET ring is remembered. An identical procedure follows in routine 116 to compute the least costly DWDM ring. If a DWDM ring is found to beat the benchmark cost and it has a lower cost per unit than the SONET ring, the DWDM ring is retained.

Now the node with the next highest demand to the current community of interest (NA, NC, ND) is added. In this example, the next node to be added is the final node NB. Costing of this ring with nodes NA, NB, NC, and ND as the add/drop multiplexers proceeds as above with SONET and DWDM ring add/drop multiplexers being tried in turn. The least costly ring for the present cycle (if any) is then compared on a cost per unit basis with the best ring found so far (this would be the previous ring of nodes NA, NC, and ND in this example. If the new ring has a lower cost per unit than the previous ring and beats its benchmark, it replaces the previous ring.

After the cost comparisons for this cycle (nodes NA, NB, NC, and ND) are made for all such combinations of add/drop multiplexers on the cycle, the best ring in terms of cost per unit is compared to using a point-to-point system for the initial largest demand on the ring. In other words, the cost of a point-to-point terminal system to carry demand from node NA to node NC is compared on a cost per unit basis to the cost of the ring. If the terminal system is lower in terms of cost per unit, it is built (added to the list of output systems) and the demand it carries is removed from the set of demands. If the best ring found is less expensive on a cost per unit basis, that ring is built, and the demand it carries is removed from the list of demands. Otherwise, the demand between nodes NA and NC is marked as having been processed and considered for ring cycle generation, and will not be used again for cycle generation. Such marked demands will eventually be routed on an individual ring, interconnected rings, or point-to-point system.

When a ring or terminal system is built, all demand carried by that system is removed from the list of input demands. Not all of the potential demand offered to the ring is carried by the ring, so some demands on the list of demands to be considered will be only decreased in amount and not eliminated.

Although the invention has been described in terms of particular embodiments and applications, one of ordinary skill in the art, in light of this teaching, can generate additional embodiments and modifications without departing from the spirit of or exceeding the scope of the claimed invention. Accordingly, the drawings and descriptions herein are proffered to facilitate comprehension of the invention and not to limit or circumscribe the scope thereof.

What is claimed is:

1. A method for designing a ring in a telecommunications network, comprising:
(a) selecting a largest demand from among a set of demands to be routed in the telecommunications network, said largest demand being associated with a respective pair of nodes in said network;
(b) generating a cycle of interest including a first path segment that starts at one node of said pair of nodes and passes through one sequence of nodes to another node of said pair of nodes, said cycle of interest further including a second path segment that starts at said another node and passes through another sequence of nodes to said one node, all of the nodes between said one node and said another node in said one sequence of nodes being different from each of the nodes between said one node and said another node in said another sequence of nodes;
(c) defining a plurality of potential rings each including, as add-drop nodes for the handling of demand, said one node, said another node and at least one additional node selected from among the nodes of said one sequence and said another sequence, each of said potential rings including only nodes on said cycle of interest, each of said potential rings carrying said largest demand and further carrying at least one additional demand for each said additional node on the respective potential ring;
(d) computing a cost for constructing each of said potential rings;
(e) comparing the computed cost of each of said potential rings at least indirectly with a cost of a pre-determined benchmark architecture carrying the same demand as the respective one of said potential rings; and
(f) determining from the compared computed costs a network structure for carrying demand at a relatively lowest cost.

2. The method defined in claim 1, further comprising inputing into said computer, prior to the selecting of said largest demand and the generating of said cycle of interest, a set of demands, nodes identified as being in said network, links between the identified nodes of said network, and possible or available equipment.

3. The method defined in claim 2 wherein said potential rings are respective combinations of said links and nodes on said cycle of interest and include one add-drop multiplexer in each node.

4. The method defined in claim 3 wherein the selecting of said largest demand, the generating of said cycle of interest, the defining of said potential rings, the computing of the construction costs, and the comparing of the computed costs are all performed automatically by a general purpose digital computer.

5. The method defined in claim 2, further comprising inputting into said computer a maximum ring circumference and eliminating from consideration any of said potential rings having a circumference larger than said maximum circumference.

6. The method defined in claim 1 wherein the computing of the costs of said potential rings includes adding in the costs of equipment installed at the nodes of said cycle of interest.

7. The method defined in claim 6 wherein the computing of the costs of said potential rings includes adding in the costs of optical add-drop multiplexers at and only at said one node, said another node and each said additional node.

8. The method defined in claim 1 wherein at least a certain one of said potential rings is a DWDM ring, the computing of the costs of said certain one of said potential rings including adding in the costs of optical add-drop multiplexers.

9. The method defined in claim 8 wherein at least another certain one of said potential rings is a SONET/SDH ring, the computing of the costs of said another certain one of said potential rings including adding in the costs of SONET add-drop multiplexers.

10. The method defined in claim 1 wherein the determining of said network structure includes identifying a one of said potential rings having a lowest cost, further comprising assigning, to the identified one of said potential rings, said largest demand and at least a portion of said additional demand.

11. The method defined in claim 10, further comprising:
eliminating said largest demand and said portion of said addition demand from said set of demands;
selecting a remaining largest demand from among a set of demands to be routed in the telecommunications network, said remaining largest demand being associated with a respective additional pair of nodes in said network;
generating an additional cycle of interest including a first additional path segment that starts at a first node of said additional pair of nodes and passes through one additional sequence of nodes to a second node of said pair of nodes, said additional cycle of interest further including a second additional path segment that starts at said second node and passes through another additional sequence of nodes to said first node, all of the nodes between said first node and said second node in said one additional sequence of nodes being different from each of the nodes between said first node and said second node in said another additional sequence of nodes;
defining a plurality of additional potential rings each including, as add-drop nodes for the handling of demand, said first node, said second node and at least one further node selected from among the nodes of said one additional sequence and said another additional sequence, each of said additional potential rings including only nodes on said additional cycle of interest, each of said additional potential rings carrying said remaining largest demand and further carrying at least one further demand for each said further node on the respective additional potential ring;
computing a cost for constructing each of said additional potential rings;
comparing the computed cost of each of said additional potential rings at least indirectly with a cost of a predetermined benchmark architecture carrying the same demand as the respective one of said additional potential rings; and
determining from the compared computed costs an additional network structure for carrying demand at a relatively lowest cost.

12. The method defined in claim 1, further comprising:
partitioning said network into a plurality of geographical areas;
breaking any demand from any distinct one of said areas area to a foreign one of said geographical areas into a portion going to a first interconnection point, from that first interconnection point to a second interconnection point of the foreign area, and from that second interconnection point to a final node;
designing a ring network within each of said geographic areas, where each of said geographic areas is designed to have transport systems handling only demand with endpoints within that respective area, the designing of each of the ring networks including the performance of steps (a) through (f); and
designing an additional network to handle the demands between the interconnection points.

13. The method defined in claim 1 wherein each of said potential rings is generated by adding a node from the nodes of said first sequence and said second sequence to a current set of add/drop nodes, the added node being that node offering the largest demand to the current set of add/drop nodes.

14. The method defined in claim 1 wherein said benchmark architecture is a dual-hub architecture.

15. A method for designing a telecommunications network comprising a plurality of nodes and links interconnecting each of said nodes with one or more other nodes of the network, comprising:
inputting, into a computer, identifications of the nodes and the links of the network and demands between pairs of said nodes;
operating said computer to define a series of rings and evaluate costs for each of said rings to determine a least-cost signal transmission structure for said network; and
building said least-cost signal transmission structure, wherein the operating of said computer includes:
defining a set of demands, said set of demands initially consisting of the input demands;
selecting a largest demand from said set of demands, said largest demand being associated with a first node and a second node;
generating a cycle between said first node and said second node, said cycle including a first path and a second path each of nodes and links extending between said first node and said second node, said second path having nodes and links all different from nodes and links of said first path;
selecting different combinations of nodes on said cycle, each combination including said first node and said second node and at least one other node on one of said first path and said second path, all of the nodes in any given one of said combinations having at least one demand to another node of said given one of said combinations;
determining a cost to construct each of said combinations; and
executing cost comparisons on said combinations to ascertain said least-cost signal transmission structure for carrying said largest demand on said network.

16. The method defined in claim 15 wherein the executing of said cost comparisons includes comparing the costs of at least some of said combinations with a cost of a benchmark architecture.

17. The method defined in claim 16 wherein said benchmark architecture is a dual-hub architecture.

18. The method defined in claim 16 wherein the executing of said cost comparisons also includes comparing the cost of a least costly ring with a cost of a point-to-point transmission system for carrying said largest demand.

19. The method defined in claim 15 wherein the determining of the cost to construct any particular one of said combinations includes costing installation of OADMs on the nodes of said particular one of said combinations, to thereby determine cost of a DWDM ring.

20. The method defined in claim 19 wherein the determining of the cost to construct any particular one of said combinations further includes costing installation of SONET/SDH equipment on the nodes of said particular one of said combinations, to thereby determine cost of a SONET/SDH ring.

21. The method defined in claim 20 wherein the costing of said SONET equipment is performed prior to the costing of said OADMs.

22. The method defined in claim 15 wherein the defining of said set of demands includes eliminating any demand which has been used as the largest demand in generating a cycle, or which has previously been routed on a system.

23. The method defined in claim 15, further comprising:
inputting ring constraints into said computer prior to the operating thereof, said ring constraints including a maximum circumference;
determining, for each individual one of said combinations, whether said individual one of said combinations violates one of said ring constaints; and
eliminating any individual one of said combinations which violates one of said ring constraints.

24. The method defined in claim 15, further comprising inputting into said computer, prior to the selecting of said largest demand and the generating of said cycle of interest, possible or available equipment.

25. The method defined in claim 15 wherein said telecommunications network is a part of a larger network, said telecommunications network serving a first geographical area, said larger network serving a second geographical area, said first geographical area being contained in said second geographical area, further comprising:
partitioning said larger network to define said telecommunications network and at least one other network;
designating one of the nodes of said first geographical area as an interconnection node for demand between nodes of said first geographical area and nodes of said larger network outside of said telecommunications network.
